(19) United States
(12) Patent Application Publication
(10) Pub. No.: US 2007/0035053 A1
(43) Pub. Date: Feb. 15, 2007

(54) Method and mould for producing transparent optical elements consisting of polymer materials

(76) Inventors: Ulrike Schulz, Kunitz (DE); Peter Munzert, Jena (DE); Norbert Kaiser, Jena (DE); Werner Hofmann, Jena (DE); Martin Bitzer, Apolda (DE); Marion Gebhardt, Apolda (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/553,284

(22) PCT Filed: Apr. 13, 2004
(86) PCT No.: PCT/DE04/00817

§ 371 Date: Sep. 26, 2006

(30) Foreign Application Priority Data
Apr. 15, 2003 (DE) 103 18 566.6

(51) Int. Cl. B29D 11/00

(52) U.S. Cl. 264/2.5; 425/808

(57) ABSTRACT

The invention relates to a method and a mold for producing transparent optical elements from polymeric materials. In this case, the optical elements that can be produced in this way are intended to have at least surface regions which have reduced interfacial reflection. According to the invention, the procedure followed here is that, in the case of a reference element which consists of a polymeric material and corresponds to the respective optical element, the entire surface or a correspondingly selected surface is exposed to the influence of high-energy ions in a vacuum. In this way, an irregular nanostructure with alternately arranged elevations and depressions lying in between is formed on the corresponding surfaces. Subsequently, a thin electrically conducting layer is applied and electrochemical forming is carried out in order to obtain a mold with a negative contour which is superposed by the nanostructure. With such a mold, the optical elements can then be produced in a molding process of the nanostructure reducing the interfacial reflection.

The invention relates to a method and molds for producing transparent optical elements from polymeric materials. The optical elements produced in this way are intended to achieve reduced interfacial reflection on at least one surface, at least in certain regions.

Such optical elements made of polymeric materials are being used increasingly frequently for a wide variety of applications. In these, reflection-induced losses are undesired and the proportion of electromagnetic radiation that is reflected at the surfaces of such optical elements and subsequently cannot be used is to be kept as small as possible. Therefore, efforts are made to keep this proportion to ≦4%, preferably ≦1% per unit area.

Various approaches have been taken in the past to counteract this problem.

For instance, it is known to form on the surfaces of optical elements layer systems which have been formed from a number of thin films arranged one on top of the other, generally as alternating layer systems. The application of such layer systems is cost-intensive, also leads to a reduction in transmission, and problems with the adhesion of such layer systems on the surfaces of optical elements cannot be ruled out.

Since such layer systems can usually be formed in a vacuum by PVD or CVD process techniques known per se, the production of such optical elements in large batch sizes involves correspondingly high costs.

Another way that has been chosen to reduce the reflected proportion of electromagnetic radiation is that of forming microstructures, the so-called motheye structures, on the corresponding surfaces that are to been made non-reflective. Corresponding solutions are described for example by A. Gombert and W. Glaubitt in Thin solid films 351 (1999), pages 73 to 78, and by D. L. Brundrett, E. N. Glysis, T. K. Gaylord in Applied optics 16 (1994), pages 2695 to 2706.

With these known solutions, a reduction in the proportion of reflected electromagnetic radiation can be achieved in each case in correspondingly limited ranges of incident angles and a correspondingly limited spectral range, that is to say for specific incident angles or for selected wavelengths of the respective electromagnetic radiation.

For the formation of the microstructures known per se, a considerable effort is required, in particular for the production of molds, since filigree negative contours have to be formed in such molds. This can take place on the one hand by means of thermal treatment with the aid of focused energy beams or photolithographic formation.

In any event, great effort is required. Furthermore, the microstructures that can be produced in this way are restricted to corresponding minimum dimensions, below which the processes cannot go.

It is therefore the object of the invention to propose a solution by which the surface of transparent optical elements made of polymeric materials can be manipulated in such a way that reduced interfacial reflection is achieved, while at the same time the production costs can be reduced and the invention can be used in the production of a wide variety of optical elements.

This object is achieved according to the invention by a method which has the features of claim 1, it being possible for a mold for producing optical elements as claimed in claim 14 to be used.

Advantageous embodiments and developments of the invention can be achieved by the features designated in the subordinate claims.

In the case of the method according to the invention for producing transparent optical elements, the surface of which has reduced interfacial reflection, at least in certain regions, the procedure followed is that, in a first step, a reference element, which may also be referred to as the “master” and consists of a polymeric material, is exposed to the influence of high-energy ions at the respective surface within a vacuum chamber. The high-energy ions are generated for example with the aid of a plasma and the respective surface of the reference element undergoes an ion bombardment.

A conventionally produced optical element which is then treated as explained above may be used with preference as the reference element.

The influence of the high-energy ions has the effect that an irregular nanostructure is formed on the respective surface of the reference element. This nanostructure is distinguished by the fact that a multiplicity of elevations with depressions lying in between have been formed, respectively alternating with one another. The elevations, and accordingly also the corresponding depressions, are formed in different dimensions over the surface, so that a refractive index gradient layer can be achieved with the aid of the corresponding nanostructure.

In a second step, the respective surface of the reference element is coated with an electrically conducting thin film.

The thickness of this thin film must merely achieve electrically conducting properties, so that, in a third method step to be carried out subsequently, a mold can be formed electrochemically.

Such a mold then has a complete negative contour of the correspondingly manipulated surface of the reference element, in which the already described nanostructure is superposed/integrated with depressions corresponding to the elevations and elevations corresponding to the depressions.

The electrochemical forming for the production of molds can be carried out in a conventional way and such molds can be obtained for example by deposition of nickel.

With the aid of the molds produced in this way, the respective optical elements can then be produced in large numbers by molding processes known per se. It is advantageously possible by electrochemical forming to produce a large number of molds from just one reference element with a formed nanostructure, whereby a further reduction in production costs can be achieved.

Apart from reference elements of a simple design, with level planar or else continuously curved surfaces, according to the invention reference elements can also be used for the production of optical elements with discontinuous surface contours. Such reference elements may have optically effective surface contours, for example Fresnel contours, and with the solution according to the invention there is the possibility of at least reducing the interfacial reflection at active flanks.

With the aid of a mold such as that created by the third method step, the optical elements can then be produced correspondingly. There is therefore the possibility of producing corresponding optical elements by hot embossing elements in sheet form or films of plastic or from pellets or granules of plastic.

However, it is likewise possible to produce optical elements by injection molding plastic in such molds.

The optical elements may, however, also be produced by an extrusion-embossing process.

For the case where optical elements are to be formed from at least two materials with a different refractive index in each case and/or by means of a more scratch-resistant surface coating, the method of UV replication is advantageously suitable.

The optical elements may be produced from a wide variety of plastics. Apart from the desired optical properties, and here in particular the refractive index, only the properties that are important for the respective molding process have to be taken into account.

In addition, there is the possibility of forming the optically effective nanostructure on a surface coating of an optical element. Such a particularly advantageous “scratch-resistant” coating may be applied for example by the sol-gel process, as an organic-inorganic hybrid polymer, as available for example under the trade name “Ormocere”, and cured after or during formation of the reflection-reducing nanostructure. Here it is preferred for the inorganic component in the hybrid polymer to be a glass component (for example silicon dioxide or a silane).

In this form, the nanostructure reducing the interfacial reflection can be formed not only on optical elements made of plastic but also on surfaces of optical elements which are formed from materials that cannot be treated by molding processes, or only with difficulty. For example, the invention can also be used for the production of optical elements which consist of a glass.

The elevations forming the nanostructure that is important for the invention, with the depressions lying in between, may be formed on the surface of the respective reference element in such a way that the heights of the various elevations formed on the surface lie in a range between 30 nm and 210 nm. In this case, the individual elevations may in each case have average thicknesses of between 30 nm and 150 nm, average thickness being intended to mean the respective thickness of an elevation at the average height in each case of the elevation.

It is preferred to produce the elevations with their respective heights and/or thicknesses in such a way that a uniform distribution, about a mean value, for example 120 nm for the height and 80 nm for the thickness, has been achieved within the respective interval.

The dimensioning of the negative impression of the nanostructure on the mold for producing the optical elements corresponds to these specifications.

It has surprisingly been found that such a nanostructure, formed on a surface of reference elements, can be transferred by the second and third method steps, according to patent claim 1, onto the surface of a mold, producing only slight deviations, if at all, from the positive contour on the surface of the reference element that is used.

Method step 1, that is the formation on reference elements of the nanostructure that substantially reduces the surface reflection, is to be described in more detail below.

Such a reference element made of a polymeric plastics material, preferably polymethylmethacrylate (PMMA), diethylene glycol bis (allylcarbonate) (CR39) or methylmethacrylate-containing polymers, is placed in a vacuum chamber and exposed there to the influence of a plasma. With this plasma, high-energy ions are generated and the desired surface of the reference element is bombarded with the ions. Used with preference is a DC argon plasma, to which oxygen is added with particular preference.

In this case, the vacuum chamber should be operated with an internal pressure below 10⁻³ mbar, with preference at around 3×10⁻⁴ mbar.

The plasma should be operated with at least 30 sccm of oxygen.

The generated ions should have energies in the range between 100 eV and 160 eV, while the respective ionic energy should be set with the material of the reference element taken into account. The respective material of the reference element should also be taken into account for the respective duration of the ion bombardment of the surface.

Therefore, reference elements of polymethylmethacrylate (PMMA) may be bombarded with ions of which the energy is kept in the range between 100 eV and 160 eV, with preference between 120 eV and 140 eV, over a time period of between 200 s and 400 s, with preference between 250 s and 350 s.

In the case of reference elements of diethylene glycol bis (allylcarbonate), the ions should have minimum energies of 120 eV, with preference 150 eV, and the ion bombardment should take place over a time period of at least 500 s.

In the case of optical elements produced by the method according to the invention, it was possible to reduce the proportion of the electromagnetic radiation reflected at the surface in the wavelength range between 400 nm and 1100 nm to a maximum of 2%. In a wavelength range between 420 nm and 870 nm, that is to say a major part of the visible light, it was possible to achieve a reduction in the reflected proportion of electromagnetic radiation to less than 1.5%.

With the invention, a wide variety of optical elements, which for electromagnetic radiation and here in particular in the spectral range of visible light, infrared light and partly also in the spectral range of UV light, can be produced for a wide variety of applications. It is also readily possible to produce a wide variety of projecting optical elements, and of these in particular Fresnel lenses, with improved optical properties at only slightly increased costs.

Also possible, however, is the production of other optical elements, such as optical windows and prisms for example.

The invention may also be advantageously used for the production of optical lenses (also lens arrays), beam splitters, optical waveguides, diffusors, lenticular lenses and for optically transparent films.

A further important application is that of transparent coverings of optical displays or optical indicating elements. For example, the indicating displays of a wide variety of electrical or electronic devices, such as for example telephones, can be produced according to the invention.

In this case, double reflections can be prevented in particular.

For certain optical indicating elements, the invention can likewise be used as a covering, it then being possible to use light sources with reduced output.

The invention is to be explained in more detail below by way of example.

In the drawing:

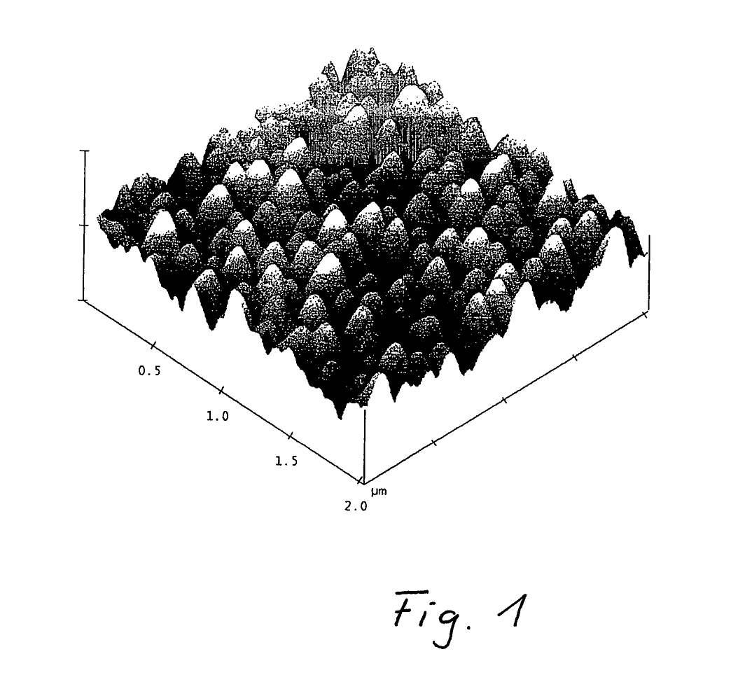

FIG. 1 shows an AFM micrograph (atomic force microscope) of a nanostructure which has been formed on a reference element of polymethylmethacrylate.

In this case, a reference element of polymethylmethacrylate was placed in a vacuum chamber and the pressure in the chamber reduced to 7 to 8×10⁻⁶ mbar. With the aid of a plasma ion source APS 904 (Leybold Optics), an argon plasma was produced with the addition of 30 sccm of oxygen, maintaining a pressure of about 3×10⁻⁴ mbar.

The plasma ion source was operated with a BIAS voltage of at least 120 V.

In this way it was possible to generate ions of which the energy was at least 120 eV and for these to be fired onto the PMMA surface of the reference element.

The ion bombardment was carried out over 300 s.

As illustrated by FIG. 1, it was possible to form an irregular nanostructure by the ion bombardment, the individual elevations respectively having different heights in the range between 50 and 120 nm and also average thicknesses in the range between 50 and 120 nm. In FIG. 1 it can also be seen that the elevations maintain an aspect ratio of about 1:1.

A thin gold film with a maximum layer thickness of 5 nm, with preference below 1 nm, was formed on the then nanostructured surface of the reference element by a thin-film process known per se.

The reference element prepared in this way was then used for electrochemical forming. In this way it was possible to produce a mold from nickel that had a virtually identical negative contour, that is also with a superposed nanostructure. This mold was then used for the production of optical elements by the hot embossing technique, replacement owing to wear only being required after taking at least 5000 impressions from it.

1. A method for producing transparent optical elements, the surface of which has reduced interfacial reflection, at least in certain regions, in which the respective surface of a reference element which consists of a polymeric material and corresponds to the respective optical element is exposed to the influence of high-energy ions in a vacuum and in this way an irregular nanostructure with alternately arranged elevations and depressions lying in between is formed on the respective surface;
subsequently, the respective surface is coated with an electrically conducting thin film, following that a mold with a negative contour which is superposed by the nanostructure is obtained by electrochemical forming and with such a mold, a nanostructure reducing the interfacial reflection is formed on at least one surface of a transparent optical element by a molding process.

2. The method as claimed in claim 1, characterized in that a reference element with an optically effective surface contour is used.

3. The method as claimed in claim 1, characterized in that the high-energy ions are generated by means of an argon/oxygen plasma.

4. The method as claimed in claim 1, characterized in that polymethylmethacrylate, diethylene glycol bis (allylcarbonate) (CR39) or methylmethacrylate-containing polymers are used for the production of the reference element.

5. The method as claimed in claim 1, characterized in that, by means of the high-energy ions, the elevations of the nanostructure are formed with heights in the range between 30 nm and 210 nm.

6. The method as claimed in claim 1, characterized in that the average thicknesses of the elevations of the nanostructure are formed in the range between 30 nm and 150 nm.

7. The method as claimed in claim 1, characterized in that the electrically conducting layer is formed as a thin metal film.

8. The method as claimed in claim 9, characterized in that the electrically conducting layer is formed from gold.

9. The method as claimed in claim 1, characterized in that the ions impinging on the respective surface have an energy in the range between 100 eV and 160 eV.

10. The method as claimed in claim 1, characterized in that an ion bombardment of the respective surface is carried out over a time period of between 200 s and 600 s.

11. The method as claimed in claim 1, characterized in that an ion bombardment is carried out at a pressure below 10⁻³ mbar.

12. The method as claimed in claim 1, characterized in that the molding of the optical elements takes place by hot embossing or by a plastics injection-molding technique.

13. The method as claimed in claim 1, characterized in that the molding of the optical elements takes place by extrusion embossing or UV replication.

14. The method as claimed in claim 1, characterized in that the surface of an optical element is coated with an organic-inorganic hybrid polymer and the nanostructure is formed with a mold on the surface of this hybrid-polymer layer.

15. A mold for producing optical elements produced by a method as claimed in claim 1, characterized in that an irregular nanostructure with alternately arranged elevations and depressions lying in between is formed on a surface, and the depressions in each case have different depths within an interval between 30 nm and 210 nm.

16. The mold as claimed in claim 15, characterized in that the depressions have an average clear width in the range between 30 nm and 150 nm.

17. The mold as claimed in claim 15, characterized in that the respective depths and/or thicknesses of depressions are distributed uniformly about a mean value within an interval.

18. The mold as claimed in claim 15, characterized in that it is formed for the production of Fresnel lenses.

19. The mold as claimed in claim 15, characterized in that it is formed for the production of optical windows, optical lenses, lenticular lenses, beam splitters, optical waveguides or optical prisms.

20. The mold as claimed in claim 15, characterized in that it is formed for the production of optically transparent films.

21. The mold as claimed in claim 15, characterized in that it is formed for the production of coverings for displays or for optical indicating elements.
